(19) United States
(12) Patent Application Publication
(10) Pub. No.: US 2025/0260165 A1
(43) Pub. Date: Aug. 14, 2025

(54) DEVICES, SYSTEMS, AND METHODS FOR IMPROVED ANTENNA PERFORMANCE IN EYEWEAR FRAMES

(71) Applicant: Meta Platforms Technologies, LLC, Menlo Park, CA (US)

(72) Inventors: Peter Eli Renner, San Jose, CA (US); Umar Azad, San Jose, CA (US); Eswarappa Channabasappa, Milpitas, CA (US); Tao Zhou, San Jose, CA (US)

(21) Appl. No.: 18/437,556

(22) Filed: Feb. 9, 2024

(51) Int. Cl. H01Q 5/48; H01Q 1/27

(52) U.S. Cl. CPC H01Q 5/48; H01Q 1/273

(57) ABSTRACT

An eyewear device that facilitates and/or supports improved antenna performance may include a temple that comprises an at least partial cavity. In some examples, the eyewear device may also include an antenna that is placed inside the at least partial cavity and/or dimensioned commensurate with a full wavelength of a carrier frequency to be applied to the antenna. Various other devices, systems, and methods are also disclosed.

### BRIEF DESCRIPTION OF DRAWINGS

The accompanying drawings illustrate a number of example embodiments and

are a part of the specification. Together with the following description, these drawings demonstrate and explain various principles of the instant disclosure.

FIG. 1 is an illustration of an exemplary eyewear device with improved antenna performance according to one or more implementations of this disclosure.

FIG. 2 is an illustration of an exemplary eyewear device with improved antenna performance according to one or more implementations of this disclosure.

FIG. 3 is an illustration of a portion of an exemplary eyewear frame that supports improved antenna performance according to one or more implementations of this disclosure.

FIG. 4 is an illustration of a portion of an exemplary eyewear frame that supports improved antenna performance according to one or more implementations of this disclosure.

FIG. 5 is an illustration of a portion of an exemplary eyewear frame that supports improved antenna performance according to one or more implementations of this disclosure.

FIG. 6 is an illustration of a portion of an exemplary eyewear frame that supports improved antenna performance according to one or more implementations of this disclosure.

FIG. 7 is an illustration of an exemplary implementation of an exemplary eyewear device that supports improved antenna performance according to one or more implementations of this disclosure.

FIG. 8 is an illustration of a portion of an exemplary eyewear frame that supports improved antenna performance according to one or more implementations of this disclosure.

FIG. 9 is an illustration of a portion of an exemplary eyewear frame that supports improved antenna performance according to one or more implementations of this disclosure.

FIG. 10 is a flow diagram of an exemplary method for improved antenna performance in eyewear frames according to one or more implementations of this disclosure.

While the exemplary embodiments described herein are susceptible to various modifications and alternative forms, specific embodiments have been shown by way of example in the appendices and will be described in detail herein. However, the exemplary embodiments described herein are not intended to be limited to the particular forms disclosed. Rather, the instant disclosure covers all modifications, combinations, equivalents, and alternatives falling within this disclosure.

### DETAILED DESCRIPTION OF EXEMPLARY EMBODIMENTS

The present disclosure is generally directed to devices, systems, and methods for improved antenna performance in eyewear frames. As will be explained in greater detail below, these devices, systems, and methods may provide numerous features and benefits.

In some examples, eyewear devices may facilitate, provide, and/or support certain smart features, such as true wireless stereo (TWS) and/or artificial reality technologies. Artificial reality may provide a rich, immersive experience in which users are able to interact with virtual objects and/or environments in one way or another. In this context, artificial reality may constitute and/or represent a form of reality that has been altered by virtual objects for presentation to a user. Such artificial reality may include and/or represent virtual reality (VR), augmented reality (AR), mixed reality, hybrid reality, or some combination and/or variation of one or more of the same.

In some examples, smart eyewear devices may take on and/or implement various shapes and/or styles. Some shapes and/or styles of eyewear devices may be highly suitable for certain smart features and/or technologies. In other words, some shapes and/or styles of eyewear devices may improve and/or enhance the performance and/or capabilities of certain smart features and/or technologies. For example, an eyewear device may take on and/or implement a shape and/or style with temples that are somewhat distanced and/or separated from the user's head. In this example, the eyewear device may include and/or implement an antenna positioned inside one of the temples toward a hinge that movably couples that temple to the front frame. In this shape and/or style of the eyewear device, the distance and/or separation between the temples and the user's head may enable the antenna to achieve high and/or improved performance.

Unfortunately, some shapes and/or styles of eyewear devices may be less suitable for certain smart features and/or technologies. In other words, some shapes and/or styles of eyewear devices may impair and/or weaken the performance and/or capabilities of certain smart features and/or technologies. For example, an eyewear device may take on and/or implement a shape and/or style with temples that closely hug a user's head. Additionally or alternatively, the shape and/or style of the eyewear device may exclude and/or omit any physical connectors that electrically and/or communicatively couple the temples—and their respective components and/or features—to one another. In this example, the eyewear device may be unable to implement an antenna positioned inside one of the temples toward a hinge that movably couples that temple to the front frame without compromising the antenna's performance and/or capabilities.

Accordingly, the lack of distance and/or separation between the temples and the user's head may disrupt and/or interfere with the antenna's performance and/or capabilities. As a result, manufacturers and/or vendors may need to redesign the configuration of components and/or features inside the temples of such smart eyewear to facilitate and/or support improved antenna performance despite the lack of distance and/or separation between the temples and the user's head. The need to redesign such a configuration may become more pronounced and/or apparent if the hinges of the smart eyewear move further back along the user's head (e.g., toward the user's ears and/or away from the user's eyes).

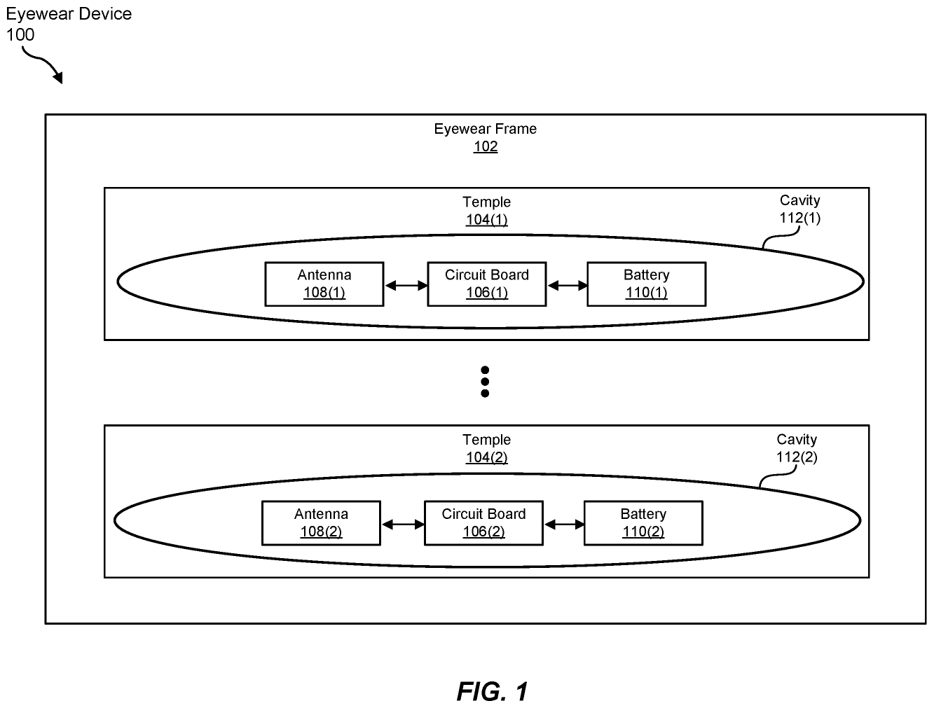

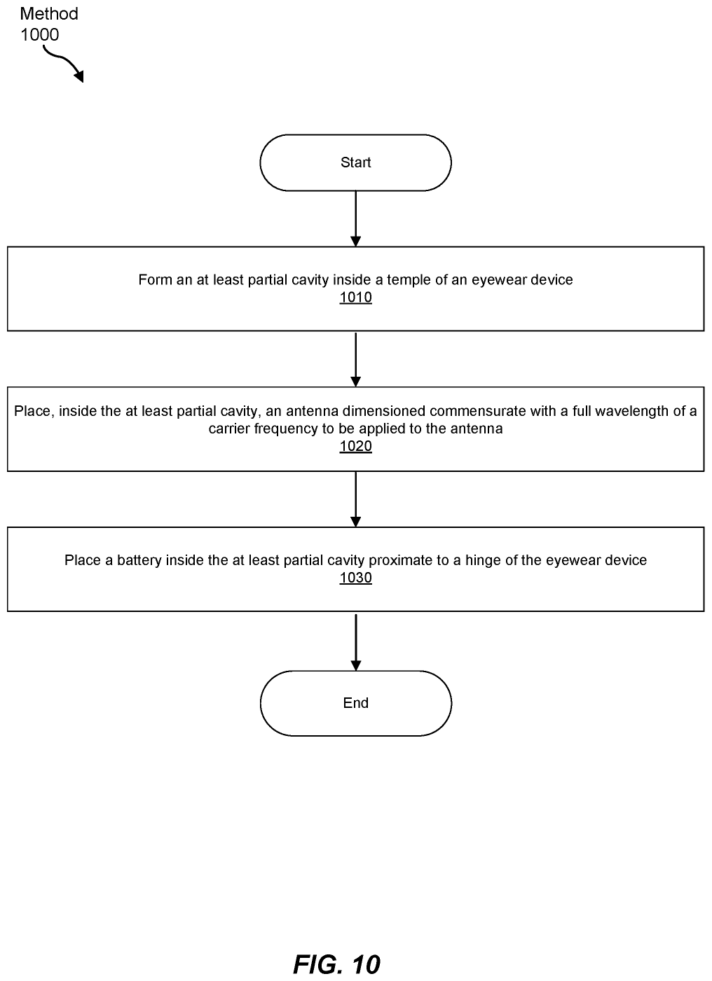

The following will provide, with reference to FIGS. 1-9, detailed descriptions of exemplary apparatuses, devices, systems, components, and corresponding configurations or implementations for improved antenna performance in eyewear frames. In addition, detailed descriptions of methods for improved antenna performance in eyewear frames will be provided in connection with FIG. 10.

FIG. 1 illustrates an exemplary eyewear device 100 for improved antenna performance. As illustrated in FIG. 1, eyewear device 100 may include and/or represent an eyewear frame 102 dimensioned to be worn by a user. In some examples, eyewear frame 102 may include and/or be equipped with temples 104(1) and 104(2). In one example, temple 104(1) may include and/or form an at least partial cavity 112(1), and/or temple 104(2) may include and/or form an at least partial cavity 112(2). In this example, temple 104(1) may include, constitute, and/or represent material that fully or partially surrounds and/or encompasses cavity 112(1), and/or temple 104(2) may include, constitute, and/or represent material that fully or partially surrounds and/or encompasses cavity 112(2).

In some examples, cavity 112(1) may constitute and/or represent empty space that is used to accommodate certain components, devices, and/or features of eyewear device 100 inside temple 104(1). Additionally or alternatively, cavity 112(2) may constitute and/or represent empty space that is used to accommodate certain components, devices, and/or features of eyewear device 100 inside temple 104(2).

In some examples, eyewear frame 102 may also include and/or be equipped circuit boards 106(1) and 106(2), antenna 108(1) and 108(2), and/or batteries 110(1) and 110(2). In one example, circuit board 106(1) may be placed, positioned, and/or embedded inside cavity 112(1) of temple 104(1). Additionally or alternatively, circuit board 106(2) may be placed, positioned, and/or embedded inside cavity 112(2) of temple 104(2).

In some examples, antenna 108(1) may be placed, positioned, and/or embedded inside cavity 112(1) of temple 104(1). In one example, antenna 108(1) may be communicatively and/or electrically coupled or connected to circuit board 106(1). Additionally or alternatively, antenna 108(2) may be placed, positioned, and/or embedded inside cavity 112(2) of temple 104(2). In one example, antenna 108(2) may be communicatively and/or electrically coupled or connected to circuit board 106(2).

In some examples, eyewear device 100 may include and/or represent a head-mounted audio system. For example, eyewear device 100 may include and/or represent a pair of smart glasses equipped with a TWS audio solution. In one example, eyewear device 100 may exclude and/or omit any physical connectors that electrically and/or communicatively couple temples 104(1) and 104(2)—and their respective components and/or features—to one another. Accordingly, eyewear device 100 may rely on and/or implement wireless communication that enables the components and/or features included in the opposing temples to communicate with one another. For example, antennas included and/or implemented in temples 104(1) and 104(2) may facilitate and/or support exchanging wireless communications (e.g., BLUETOOTH communications) with one another in connection with and/or on behalf of circuit boards 106(1) and 106(2).

In some examples, eyewear device 100 may include and/or represent a head-mounted display (HMD). In one example, an HMD may include and/or represent any type or form of display device or system that is worn on or about the user's face and displays virtual content, such as computer-generated objects and/or AR content, to the user. HMDs may present and/or display content in any suitable way, including via a display screen, a liquid crystal display (LCD), a light-emitting diode (LED), a microLED display, a plasma display, a projector, a cathode ray tube, an optical mixer, combinations or variations of one or more of the same. HMDs may present and/or display content in one or more media formats. For example, HMDs may display video, photos, computer-generated imagery (CGI), and/or variations or combinations of one or more of the same. Additionally or alternatively, HMDs may include and/or incorporate see-through lenses that enable the user to see the user's surroundings in addition to such computer-generated content.

HMDs may provide diverse and/or distinctive user experiences. Some HMDs may provide virtual-reality experiences (i.e., they may display computer-generated or pre-recorded content), while other HMDs may provide real-world experiences (i.e., they may display live imagery from the physical world). HMDs may also provide any mixture of live and virtual content. For example, virtual content may be projected onto the physical world (e.g., via optical or video see-through lenses), which may result in AR and/or mixed-reality experiences.

In some examples, circuit boards 106(1) and 106(2) may each include and/or represent a wafer of semiconductor materials (such as silicon, germanium, and/or gallium arsenide). In one example, circuit boards 106(1) and 106(2) may each include and/or represent a wafer of electrical insulator materials (such as silicon dioxide, sapphire, aluminum oxide, polymers, and/or ceramics). Additionally or alternatively, circuit boards 106(1) and 106(2) may each include and/or represent multiple layers of insulation materials.

In some examples, circuit boards 106(1) and 106(2) may each include and/or contain conductive traces and/or through-silicon vias that carry and/or route signals across and/or throughout the silicon. Although not necessarily illustrated and/or labelled in this way in FIG. 1, one or more of circuit boards 106(1) and 106(2) may include and/or represent one or more additional components, devices, and/or features that form part of one or more circuits incorporated in eyewear device 100. For example, circuit boards 106(1) and 106(2) may each include, contain, and/or represent certain electrical and/or electronic components or devices that enable eyewear device 100 to produce and/or provide artificial-reality experiences for the user.

In some examples, one or more of batteries 110(1) and 110(2) may power, energize, and/or support the operation of eyewear device 100 for the user. For example, batteries 110(1) and 110(2) may power, energize, and/or support circuitry on circuit boards 106(1) and 106(2), respectively. Batteries 110(1) and 110(2) may include and/or represent any type or form of portable electric power source. In one example, batteries 110(1) and 110(2) may include and/or represent electrochemical cells capable of sourcing and/or providing electric power or current to one or more circuits and/or devices disposed on circuit boards 106(1) and 106(2), respectively. Examples of batteries 110(1) and 110(2) include, without limitation, lithium-ion batteries, lithium-polymer batteries, primary lithium batteries, alkaline batteries, aluminum-ion batteries, rechargeable batteries, primary cell batteries, secondary cell batteries, flow batteries, metal-air batteries, nickel-cadmium batteries, nickel-metal hydride batteries, combinations or variations of one or more of the same, and/or any other suitable type of batteries.

In some examples, antennas 108(1) and 108(2) may each include and/or represent any type or form of device and/or interface that facilitates and/or supports the propagation of radio waves between metal conductors and/or space (e.g., air). In one example, antenna 108(1) and/or antenna 108(2) may include and/or represent part of at least one radio that transmits and/or receives communications via space. In this example, the radio may also include and/or represent various other components, such as radio-frequency (RF) RF circuitry.

In some examples, antennas 108(1) and 108(2) may be sized, dimensioned, and/or shaped in any suitable way to facilitate and/or support improved performance in eyewear frames. For example, antenna 108(1) may be sized and/or dimensioned commensurate with a full wavelength of the carrier frequency applied to antenna 108(1). More specifically, if the carrier frequency of antenna 108(1) is 2.4 gigahertz, then antenna 108(1) may have a length of approximately 12.5 centimeters. In this example, the 12.5-centimeter length of antenna 108(1) may constitute and/or represent a full wavelength of the 2.4 gigahertz carrier frequency.

In some examples, antennas 108(1) and 108(2) may include and/or represent standalone antenna structures that are separate and/or distinct from circuit boards 106(1) and 106(2), respectively. In one example, antenna 108(1) may include and/or represent a wire antenna, a flex antenna, a BLUETOOTH antenna, and/or a WI-FI antenna that is communicatively coupled to circuit board 106(1). Additionally or alternatively, antenna 108(2) may include and/or represent a wire antenna, a flex antenna, a BLUETOOTH antenna, and/or a WI-FI antenna that is communicatively coupled to circuit board 106(2).

In some examples, antenna 108(1) may be fairly low-profile relative to circuit board 106(1). For example, antenna 108(1) may sit and/or reside between 1 millimeter and 2 millimeters above circuit board 106(1) within cavity 112(1). In other words, antenna 108(1) may have a ground clearance of between 1 millimeter and 2 millimeters relative to circuit board 106(1) within cavity 112(1).

In some examples, antennas 108(1) and 108(2) may each include and/or represent any type or form of material and/or substance capable of radiating RF energy for transmitting and/or receiving RF communications. Examples of materials used to form antenna 108(1) and 108(2) include, without limitation, magnesiums, coppers, aluminums, steels, stainless steels, silvers, golds, alloys, nickels, combinations or variations of one or more of the same, and/or any other suitable materials. In certain implementations, the wireless technologies supported by antennas 108(1) and 108(2) and/or the RF circuitry may direct, influence, and/or control certain features (e.g., virtual features, dimming features, audio features, etc.) of eyewear device 100 in connection with the user's experience.

In some examples, the RF circuitry may include and/or represent one or more circuits designed to produce, carry, transmit, receive, process, and/or otherwise use wireless signals within the RF band and/or spectrum. For example, the RF circuitry may include and/or represent all or a portion of an RF integrated circuit (RFIC) incorporated in eyewear device 100.

In this example, the RFIC may contain and/or implement various components that support and/or facilitate RF communications via antenna 108(1) and/or antenna 108(2). Examples of such RF components include, without limitation, signal generators, filters, transmission lines, waveguides, radios, mixers, amplifiers, oscillators, couplers, detectors, combiners, receivers, transmitters, transceivers, tuners, modulators, demodulators, shielding, circuit boards, transistors, processors, resistors, capacitors, diodes, inductors, switches, registers, flipflops, connections, ports, antenna ports, RF frontends, portions of one or more of the same, combinations or variations of one or more of the same, and/or any other suitable components.

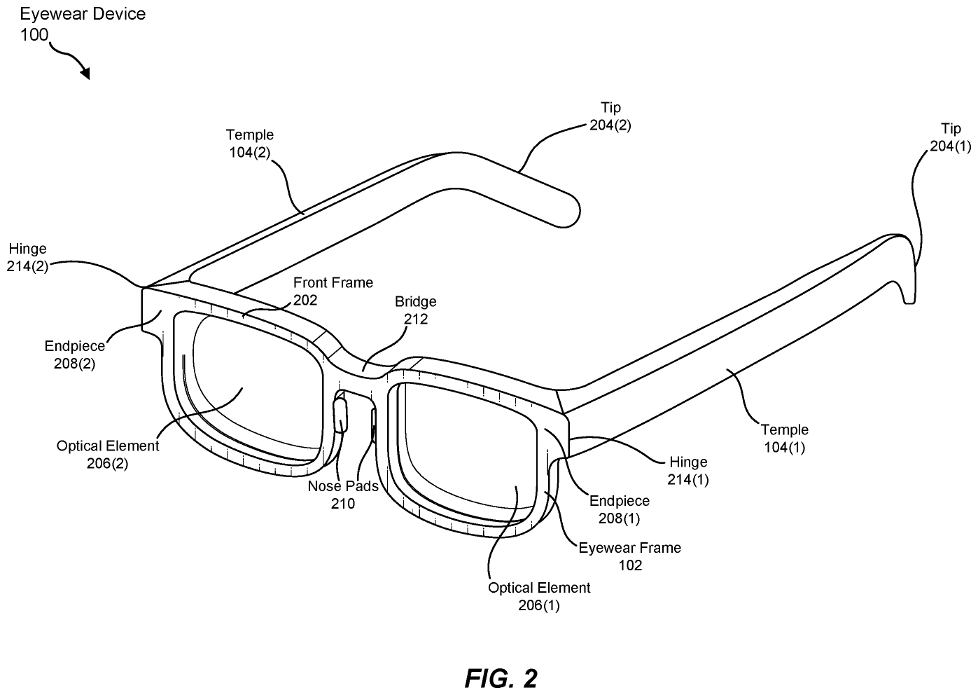

FIG. 2 illustrates an exemplary implementation of eyewear device 100, which facilitates and/or supports improved antenna performance. In some examples, eyewear device 100 in FIG. 2 may include and/or represent certain components and/or features that perform and/or provide functionalities that are similar and/or identical to those described above in connection with FIG. 1. As illustrated in FIG. 2, eyewear device 100 may include and/or represent eyewear frame 102 that facilitates, supports, and/or provides TWS and/or artificial-reality experiences for a user. In one example, eyewear frame 102 may include and/or represent a front frame 202, temples 104(1) and 104(2), tips 204(1) and 204(2), optical elements 206(1) and 206(2), hinges 214(1) and 214(2), endpieces 208(1) and 208(2), nose pads 210, and/or a bridge 212.

In some examples, optical elements 206(1) and 206(2) may be inserted and/or installed in front frame 202. In other words, optical elements 206(1) and 206(2) may be coupled to, incorporated in, and/or held by eyewear frame 102. In one example, optical elements 206(1) and 206(2) may be configured and/or arranged to provide one or more virtual features for presentation to a user wearing eyewear device 100. These virtual features may be driven, influenced, and/or controlled by one or more wireless technologies supported by eyewear device 100.

In some examples, optical elements 206(1) and 206(2) may each include and/or represent optical stacks, lenses, and/or films. In one example, optical elements 206(1) and 206(2) may each include and/or represent various layers that facilitate and/or support the presentation of virtual features and/or elements that overlay real-world features and/or elements. Additionally or alternatively, optical elements 206(1) and 206(2) may each include and/or represent one or more screens, lenses, and/or fully or partially see-through components. Examples of optical elements 206(1) and (2) include, without limitation, electrochromic layers, dimming stacks, transparent conductive layers (such as indium tin oxide films), metal meshes, antennas, transparent resin layers, lenses, films, combinations or variations of one or more of the same, and/or any other suitable optical elements.

In some examples, front frame 202 may include and/or represent a rim of eyewear device 100. In one example, tips 204(1) and 204(2) may each include and/or represent a temple tip and/or an earpiece of eyewear device 100. Additionally or alternatively, one or more audio transducers (e.g., speakers) may be incorporated and/or embedded in one or more of temples 104(1) and 104(2) above the ear(s) of a user wearing eyewear device 100.

In some examples, hinges 214(1) and 214(2) may movably couple, secure, and/or attach temples 104(1) and 104(2), respectively, to front frame 202. For example, hinges 214(1) and 214(2) may movably couple, secure, and/or attach temples 104(1) and 104(2) to endpieces 208(1) and 208(2), respectively, of eyewear frame 102. In one example, battery 110(1) may be placed and/or positioned inside cavity 112(1) of temple 104(1) proximate to hinge 214(1) and/or opposite tip 204(1). In this example, circuit board 106(1) may be placed and/or positioned inside cavity 112(1) of temple 104(1) proximate to tip 204(1) and/or opposite hinge 214(1). Additionally or alternatively, an audio transducer (e.g., as speaker) may be placed and/or positioned inside cavity 112(1) of temple 104(1) between circuit board 106(1) and battery 110(1).

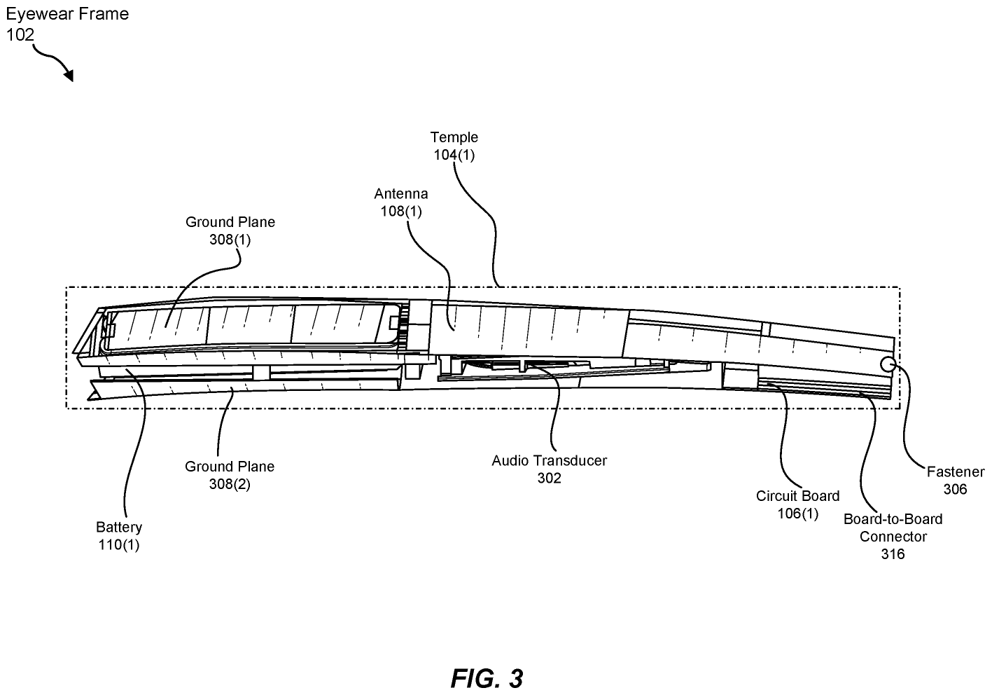

FIG. 3 illustrates an exemplary implementation of eyewear frame 102, which facilitates and/or supports improved antenna performance. In some examples, eyewear frame 102 in FIG. 3 may include and/or represent certain components and/or features that perform and/or provide functionalities that are similar and/or identical to those described above in connection with either FIG. 1 or FIG. 2. In one example, FIG. 3 may include and/or represent a see-through view and/or depiction of certain components and/or devices housed in cavity 112(1) of temple 104(1). For example, temple 104(1) may include and/or form an at least partial cavity in which circuit board 106(1), antenna 108(1), battery 110(1), an audio transducer 302, a fastener 306, a flexible board-to-board connector 316, and/or ground planes 308(1) and 308(2) are housed.

In some examples, circuit board 106(1) may be communicatively and/or electrically coupled to circuit board 106(1). In one example, circuit board 106(1) may be communicatively and/or electrically coupled to circuit board 106(1) via fastener 306 (such as one or more spring clips and/or standoffs). In this example, antenna 108(1) may be positioned and/or placed proximate to, above, and/or along a side, edge, and/or corner of circuit board 106(1) inside temple 104(1). For example, one or more spring clips may secure antenna 108(1) to circuit board 106(1) while simultaneously offsetting antenna 108(1) from circuit board 106(1). In certain implementations, one or more RF feeds for antenna 108(1) may be positioned and/or placed proximate and/or adjacent to the spring clip(s). Additionally or alternatively, the spring clip(s) may serve and/or function as a shorting line for antenna 108(1).

In some examples, eyewear frame 102 may include and/or represent a flexible board-to-board connector 316 that electrically couples circuit board 106(1) to a ground reference, plane, and/or signal. In one example, ground planes 308(1) and 308(2) may be positioned and/or placed on opposing sides of battery 110(1). For example, ground plane 308(1) may be positioned and/or placed on the side of temple 104(1) that is further away from the user's head, and ground plane 308(2) may be positioned and/or placed on the side of temple 104(2) that is closer toward the user's head. In this example, ground plane 308(1) may be defined and/or shaped at least in part by a cutout that follows some or all of the perimeter of battery 110(1). In certain implementations, ground plane 308(1) may be communicatively and/or electrically coupled to antenna 108(1) by a small strip connector.

In some examples, audio transducer 302 may be placed and/or positioned inside cavity 112(1) of temple 104(1) between circuit board 106(1) and battery 110(1). In one example, audio transducer 302 may be used to output audio waves for listening by a user. For example, audio transducer 302 may include and/or represent an audio speaker and/or headphone.

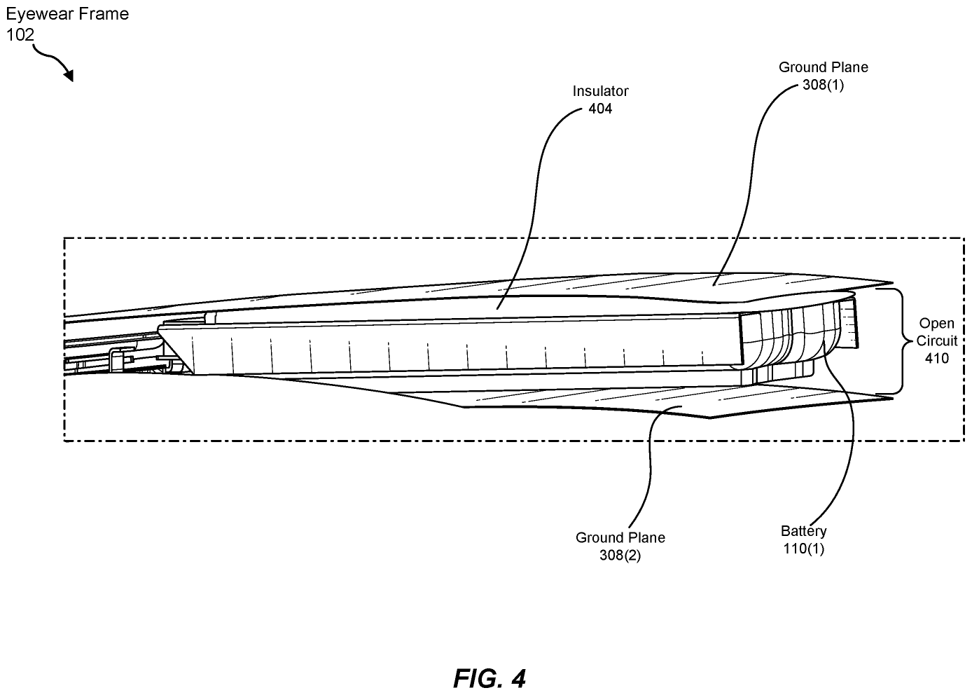

FIG. 4 illustrates an exemplary implementation of eyewear frame 102, which facilitates and/or supports improved antenna performance. In some examples, eyewear frame 102 in FIG. 4 may include and/or represent certain components and/or features that perform and/or provide functionalities that are similar and/or identical to those described above in connection with any of FIGS. 1-3. In one example, FIG. 4 may include and/or represent a see-through view and/or depiction of certain components and/or devices housed in cavity 112(1) of temple 104(1). For example, temple 104(1) may include and/or form an at least partial cavity in which battery 110(1), ground planes 308(1) and 308(2), and/or an insulator 404 are housed.

In some examples, ground planes 308(1) and 308(2) may be positioned and/or placed on opposing sides of battery 110(1). In one example, insulator 404 may be positioned and/or placed between battery 110(1) and ground plane 108(1) or 108(2). In this example, insulator 404 may include and/or represent a wrapping and/or shielding that envelops and/or surrounds some or all of battery 110(1). Additionally or alternatively, an open circuit 410 may be included and/or incorporated within cavity 112(1) of temple 104(1) toward hinge 214(1). For example, ground planes 308(1) and 308(2) may form, create, and/or constitute open circuit 410 (at least relative to those ground planes) at one end of temple 104(1).

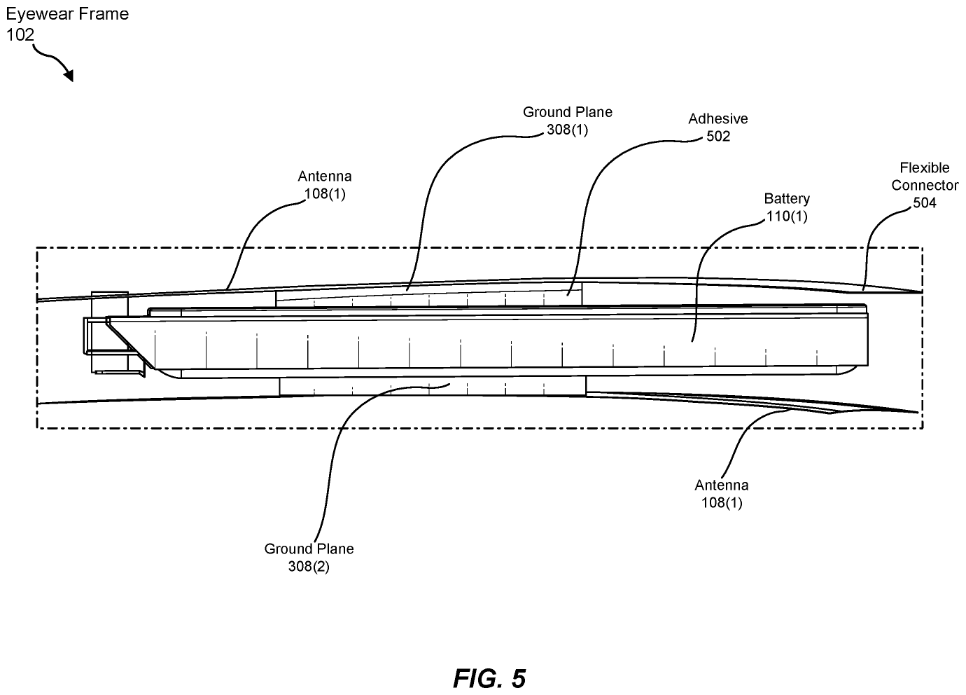

FIG. 5 illustrates an exemplary implementation of eyewear frame 102, which facilitates and/or supports improved antenna performance. In some examples, eyewear frame 102 in FIG. 5 may include and/or represent certain components and/or features that perform and/or provide functionalities that are similar and/or identical to those described above in connection with any of FIGS. 1-4. In one example, FIG. 5 may include and/or represent a see-through view and/or depiction of certain components and/or devices housed in cavity 112(1) of temple 104(1). For example, temple 104(1) may include and/or form an at least partial cavity in which antenna 108(1), battery 110(1), ground planes 308(1) and 308(2), an adhesive 502, and/or a flexible connector 504 are housed.

In some examples, adhesive 502 may couple, attach, and/or secure battery 110(1) to ground plane 308(1) or 308(2). Examples of adhesive 502 include, without limitation, epoxies, glues, silicones, conductive materials, combinations or variations of one or more of the same, and/or any other suitable adhesives.

In some examples, antenna 108(1) may be disposed, implemented, and/or incorporated in or on flexible connector 504. In one example, antenna 108(1) and/or flexible connector 504 may span and/or extend nearly or approximately the length of cavity 112(1) and/or temple 104(1). In certain implementations, the length of cavity 112(1) and/or temple 104(1) may be substantially commensurate with and/or equal to a full wavelength of the corresponding carrier frequency to be applied to antenna 108(1).

In some examples, flexible connector 504 may include and/or represent various components, sections, segments, signals, and/or antennas combined in a flexible housing and/or cable assembly. For example, flexible connector 504 may include and/or represent various signals, such as power traces and/or signals, ground planes and/or signals, and/or communication signals and/or buses. In this example, such communication signals and/or buses may include and/or represent audio signals for audio transducer 302, battery power lines, and/or grounding points. Additionally or alternatively, flexible connector 504 may include and/or represent antenna 108(1), which spans across a full wavelength of the corresponding carrier frequency within cavity 112(1) of temple 104(1).

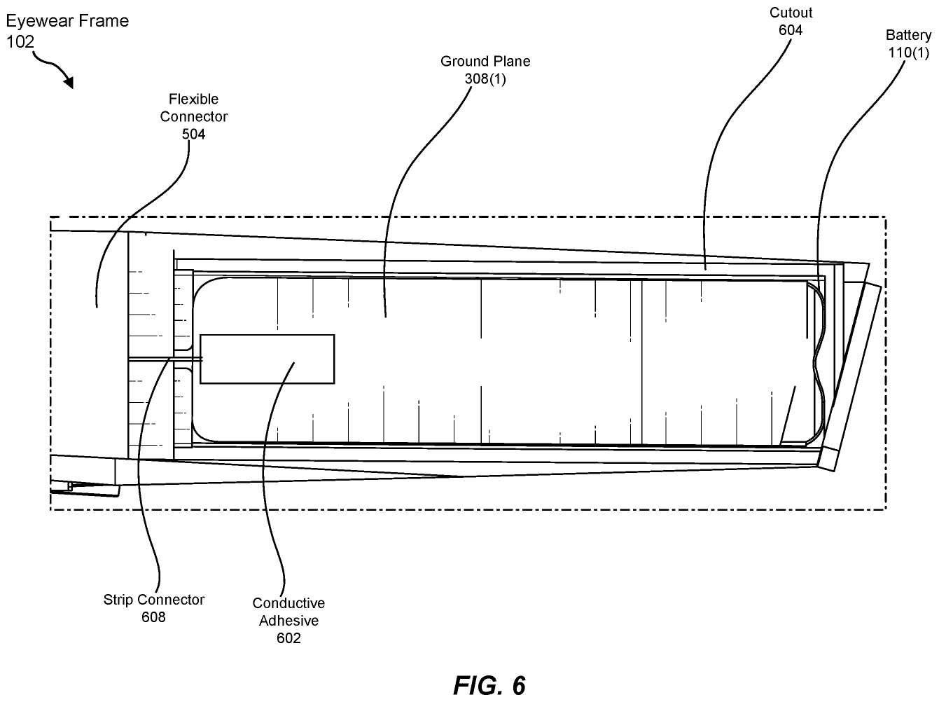

FIG. 6 illustrates an exemplary implementation of eyewear frame 102, which facilitates and/or supports improved antenna performance. In some examples, eyewear frame 102 in FIG. 6 may include and/or represent certain components and/or features that perform and/or provide functionalities that are similar and/or identical to those described above in connection with any of FIGS. 1-5. In one example, FIG. 6 may include and/or represent a see-through view and/or depiction of certain components and/or devices housed in cavity 112(1) of temple 104(1). For example, temple 104(1) may include and/or form an at least partial cavity in which battery 110(1), ground plane 308(1), flexible connector 504, a strip connector 608, a conductive adhesive 602, and/or a cutout 604 are housed.

In some examples, cutout 604 may include and/or represent a portion of antenna 108(1) and/or flexible connector 504 that is removed and/or omitted. In one example, cutout 604 may include and/or represent a space, gap, and/or distance that separates and/or distinguishes antenna 108(1) and/or flexible connector 504 from ground plane 308(1). For example, cutout 404 may constitute and/or form a U-shape on the side of temple 104(1) positioned further away from the user's head, and a rectangular cutout (not necessarily illustrated and/or labeled in FIG. 6) may be positioned on the opposite side of battery 110(1) nearer to the user's head in temple 104(1). In this example, cutout 404 and the rectangular cutout may collectively function and/or serve to direct the electric currents around battery 110(1), thereby effectively avoiding battery 110(1). Additionally or alternatively, strip connector 608 may communicatively and/or electrically couple antenna 108(1) and/or flexible connector 504 to ground plane 308(1). In certain implementations, strip connector 608 may achieve and/or accomplish the communicative and/or electrical coupling with ground plane 308(1) via conductive adhesive 602.

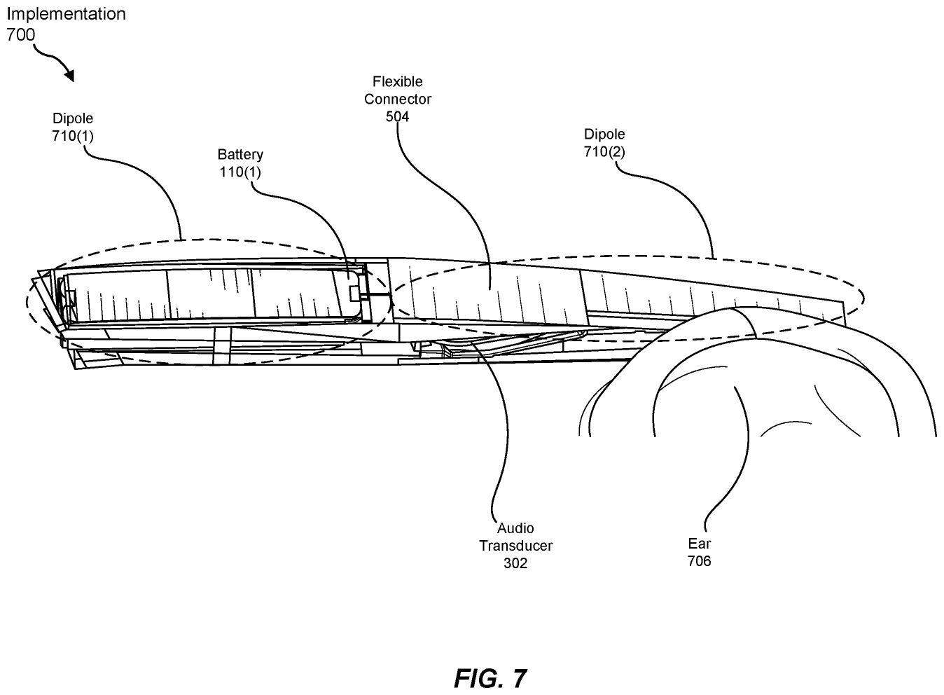

FIG. 7 illustrates an exemplary implementation 700 of eyewear device 100, which facilitates and/or supports improved antenna performance. In some examples, implementation 700 may include and/or represent certain components and/or features that perform and/or provide functionalities that are similar and/or identical to those described above in connection with any of FIGS. 1-6. In one example, FIG. 7 may include and/or represent a see-through view and/or depiction of certain components and/or devices housed in cavity 112(1) of temple 104(1) in eyewear device 100 worn above an ear 706 of a user. For example, temple 104(1) may include and/or form an at least partial cavity in which battery 110(1), flexible connector 504, dipoles 710(1) and 710(2) of antenna 108(1), and/or audio transducer 302 are housed.

In some examples, antenna 108(1) may include and/or represent dipoles 710(1) and 710(2). In one example, dipole 710(1) may be positioned and/or placed proximate to hinge 214(1) of eyewear frame 102. In certain implementations, dipole 710(1) may include and/or represent one or more of ground planes 308(1) and 308(2). Additionally or alternatively, dipole 710(2) may be positioned and/or placed proximate to tip 204(1) of temple 104(1).

In some examples, dipoles 710(1) and 710(2) may each include and/or represent opposing ends and/or a middle region of antenna 108(1). In one example, the middle region of each of dipoles 710(1) and 710(2) may experience higher current flow than the opposing ends of each of dipoles 710(1) and 710(2). Additionally or alternatively, the middle region of each of dipoles 710(1) and 710(2) may experience lower electric fields than the opposing ends of each of dipoles 710(1) and 710(2).

Put differently, the opposing ends of each of dipoles 710(1) and 710(2) may experience lower current flow than the middle region of each of dipoles 710(1) and 710(2). Additionally or alternatively, the opposing ends of each of dipoles 710(1) and 710(2) may experience higher electric fields than the middle region of each of dipoles 710(1) and 710(2).

In some examples, dipole 710(1) may include and/or represent an open-circuit end aimed toward hinge 214(1) of eyewear frame 102. In one example, dipole 710(1) may include and/or represent a shorting patch positioned and/or located approximately one-quarter wavelength of the corresponding carrier frequency inward from that open-circuit end. Additionally or alternatively, dipole 710(2) may include and/or represent an open-circuit end aimed toward tip 204(1) of temple 104(1). In one example, dipole 710(2) may include and/or represent a shorting patch positioned and/or located approximately one-quarter wavelength of the corresponding carrier frequency inward from that open-circuit end. In this example, the approximately one-quarter wavelength of the corresponding carrier frequency may be within a certain threshold of precisely one-quarter wavelength of the corresponding carrier frequency.

In some examples, dipoles 710(1) and 710(2) may constitute and/or form an antenna comprising two conductive (e.g., copper) planes connected together via one or more shorting strips. In one example, dipoles 710(1) and 710(2) may resonate individually and/or together (e.g., in sync), and a ground plane (not necessarily illustrated and/or labelled in FIG. 7) may be positioned on the side opposite dipoles 710(1) and 710(2) in temple 104(1). In this example, the ground plane positioned on the side opposite dipoles 710(1) and 710(2) may shield and/or block the radiation from the user's head, thereby improving the efficiency and/or performance of the antenna. Additionally or alternatively, the sides of the ground plane may wrap up and/or around the ends of the structures, components, and/or devices inside temple 104(1) to keep the edges of the ground plane away from the user's head, thereby diverting and/or shifting much of the electric currents away from the user's head.

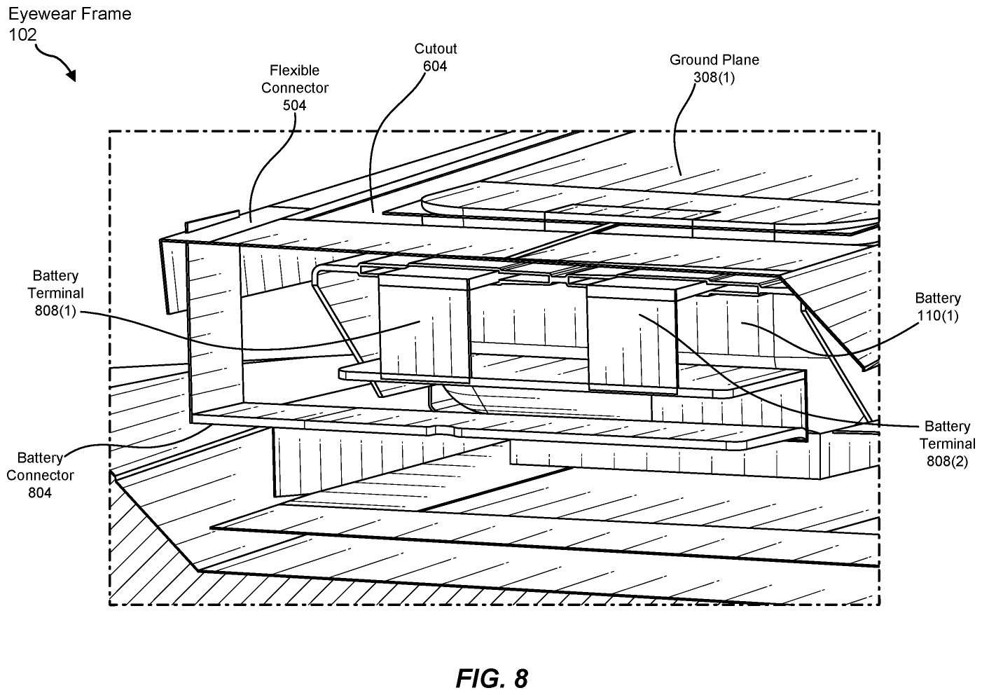

FIG. 8 illustrates an exemplary implementation of eyewear frame 102, which facilitates and/or supports improved antenna performance. In some examples, eyewear frame 102 may include and/or represent certain components and/or features that perform and/or provide functionalities that are similar and/or identical to those described above in connection with any of FIGS. 1-7. In one example, FIG. 8 may include and/or represent a see-through view and/or depiction of certain components and/or devices housed in cavity 112(1) of temple 104(1) in eyewear device 100. For example, temple 104(1) may include and/or form an at least partial cavity in which battery 110(1), flexible connector 504, ground plane 308(1), cutout 604, a battery connector 804, and/or battery terminals 808(1) and 808(2) are housed.

In some examples, flexible connector 504 may be communicatively and/or electrically coupled to battery 110(1) via battery connector 804 and/or battery terminals 808(1) and 808(2). For example, flexible connector 504 may be communicatively and/or electrically coupled to battery connector 804. Additionally or alternatively, battery connector 804 may be communicatively and/or electrically coupled between flexible connector 504 and battery terminals 808(1) and 808(2). Further, battery terminals 808(1) and 808(2) may be communicatively and/or electrically coupled between battery connector 804 and battery 110(1).

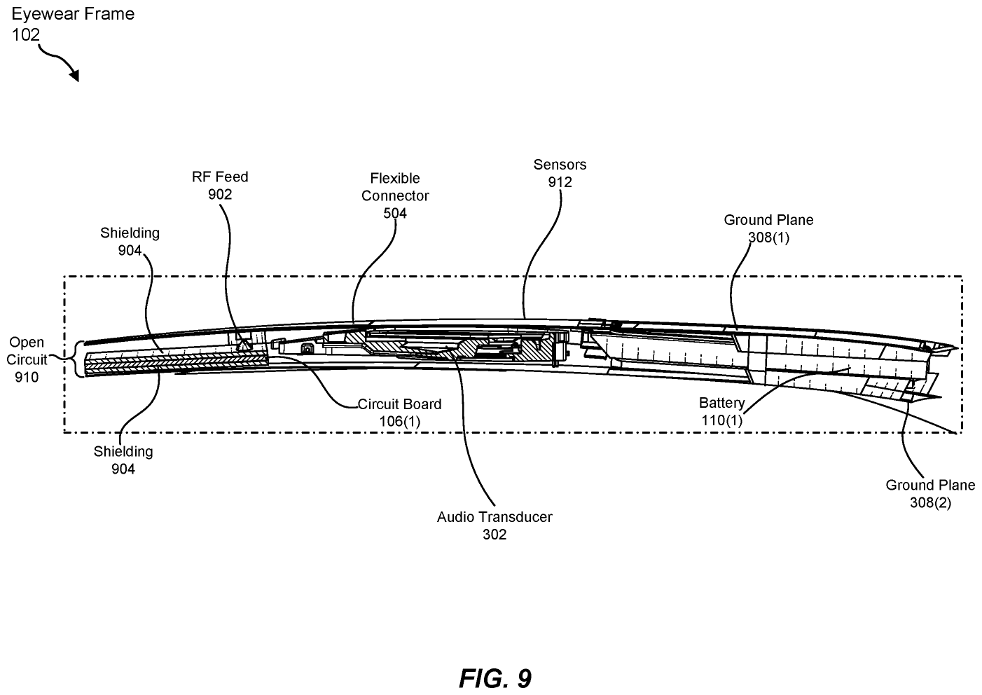

FIG. 9 illustrates an exemplary implementation of eyewear frame 102, which facilitates and/or supports improved antenna performance. In some examples, eyewear frame 102 may include and/or represent certain components and/or features that perform and/or provide functionalities that are similar and/or identical to those described above in connection with any of FIGS. 1-8. In one example, FIG. 9 may include and/or represent a see-through view and/or depiction of certain components and/or devices housed in cavity 112(1) of temple 104(1) in eyewear device 100. For example, temple 104(1) may include and/or form an at least partial cavity in which battery 110(1), flexible connector 504, ground plane 308(1), circuit board 106(1), an RF feed 902, a shielding 904, one or more sensors 912, and/or an open circuit 910 are housed.

In some examples, antenna 108(1) may be powered, energized, activated, and/or controlled by RF feed 902. For example, RF feed 902 may be communicatively coupled between circuit board 106(1) and antenna 108(1). In one example, RF feed 902 may facilitate and/or provide connectivity or continuity between RF circuitry on circuit board 106(1) and antenna 108(1).

In some examples, shielding 904 may be positioned and/or placed on one or more sides of circuit board 106(1). In one example, shielding 904 may include and/or represent a wrapping and/or insulator that envelops and/or surrounds some or all of circuit board 106(1). Additionally or alternatively, open circuit 910 may be included and/or incorporated within cavity 112(1) toward tip 204(1) of temple 104(1). For example, flexible connector 504 and/or an opposing conductive plane may form, create, and/or constitute open circuit 910 at one end of temple 104(1).

In some examples, sensors 912 may include and/or represent one or more additional devices that influence and/or control activity and/or behavior of eyewear device 100 in one way or another. For example, sensors 912 may include and/or represent a capacitive touch sensor and/or a microphone. In one example, the capacitive touch sensor may influence and/or control the volume level of audio transducer 302. Additionally or alternatively, the microphone may capture words spoken and/or sounds made by a user wearing eyewear device 100. In this example, eyewear device 100 may transmit representations of those words and/or sounds to a remote device via antenna 108(1).

In some examples, the various apparatuses, devices, and systems described in connection with FIGS. 1-8 may include and/or represent one or more additional circuits, components, and/or features that are not necessarily illustrated and/or labeled in FIGS. 1-8. For example, the apparatuses, devices, and systems illustrated in FIGS. 1-8 may also include and/or represent additional analog and/or digital circuitry, onboard logic, transistors, RF transmitters, RF receivers, transceivers, antennas, resistors, capacitors, diodes, inductors, switches, registers, flipflops, digital logic, connections, traces, buses, semiconductor (e.g., silicon) devices and/or structures, processing devices, storage devices, circuit boards, sensors, packages, substrates, housings, combinations or variations of one or more of the same, and/or any other suitable components. In certain implementations, one or more of these additional circuits, components, and/or features may be inserted and/or applied between any of the existing circuits, components, and/or features illustrated in FIGS. 1-8 consistent with the aims and/or objectives described herein. Accordingly, the couplings and/or connections described with reference to FIGS. 1-8 may be direct connections with no intermediate components, devices, and/or nodes or indirect connections with one or more intermediate components, devices, and/or nodes.

In some examples, the phrase “to couple” and/or the term “coupling,” as used herein, may refer to a direct connection and/or an indirect connection. For example, a direct coupling between two components may constitute and/or represent a coupling in which those two components are directly connected to each other by a single node that provides continuity from one of those two components to the other. In other words, the direct coupling may exclude and/or omit any additional components between those two components.

Additionally or alternatively, an indirect coupling between two components may constitute and/or represent a coupling in which those two components are indirectly connected to each other by multiple nodes that fail to provide continuity from one of those two components to the other. In other words, the indirect coupling may include and/or incorporate at least one additional component between those two components.

In some examples, one or more components and/or features illustrated in FIGS. 1-8 may be excluded and/or omitted from the various apparatuses, devices, and/or systems described in connection with FIGS. 1-8. For example, although FIG. 1 illustrates antenna 108(2), circuit board 106(2), and battery 110(2) as being implemented and/or incorporated in temple 104(2), alternative embodiments of eyewear device 100 may exclude and/or omit antenna 108(2), circuit board 106(2), and battery 110(2). In other words, some embodiments of eyewear device 100 may include and/or represent only a single antenna, circuit board, and/or battery implemented in only a single temple.

Moreover, although these apparatuses, devices, and/or systems are often described above in terms of their configurations and/or capabilities, these apparatuses, devices, and/or systems may also actually perform any of the functionalities, behaviors, and/or services associated with those configurations and/or capabilities. For example, a controller configured to obtain radiation measurements may actually obtain such radiation measurements.

FIG. 10 is a flow diagram of an exemplary method 1000 for improved antenna performance in eyewear frames. In one example, the steps shown in FIG. 10 may be achieved and/or accomplished by a computing equipment manufacturer or subcontractor that creates and/or assembles eyewear frames for smart eyewear. Additionally or alternatively, the steps shown in FIG. 10 may incorporate and/or involve certain sub-steps and/or variations consistent with the descriptions provided above in connection with FIGS. 1-9.

As illustrated in FIG. 10, method 1000 may include the step of forming an at least partial cavity inside a temple of an eyewear device (1010). Step 1010 may be performed in a variety of ways, including any of those described above in connection with FIGS. 1-9. For example, a computing equipment manufacturer or subcontractor may form, create, and/or make an at least partial cavity inside a temple of an eyewear device.

Method 1000 may also include the step of placing, inside the at least partial cavity, an antenna dimensioned commensurate with a full wavelength of a carrier frequency to be applied to the antenna (1020). Step 1020 may be performed in a variety of ways, including any of those described above in connection with FIGS. 1-9. For example, the computing equipment manufacturer or subcontractor may place, position, and/or install an antenna inside the at least partial cavity. In this example, the antenna may be sized, shaped, and/or dimensioned commensurate with a full wavelength of a carrier frequency to be applied to the antenna.

Method 1000 may further include the step of placing a battery inside the at least partial cavity proximate to a hinge of the eyewear frame (1030). Step 1030 may be performed in a variety of ways, including any of those described above in connection with FIGS. 1-9. For example, the computing equipment manufacturer or subcontractor may place, position, and/or install a battery inside the at least partial cavity proximate to a hinge of the eyewear frame.

### EXAMPLE EMBODIMENTS

Example 1: An eyewear device comprising a temple that comprises an at least partial cavity and an antenna that is placed inside the at least partial cavity and dimensioned commensurate with a full wavelength of a carrier frequency to be applied to the antenna.
Example 2: The eyewear device of Example 1, further comprising a circuit board placed inside the at least partial cavity proximate to a tip of the temple, wherein the antenna is communicatively coupled to the circuit board.
Example 3: The eyewear device of either Example 1 or Example 2, wherein the antenna is communicatively coupled to the circuit board via at least one fastener.
Example 4: The eyewear device of any of Examples 1-3, wherein the at least one fastener comprises a spring clip.
Example 5: The eyewear device of any of Examples 1-4, further comprising a flexible board-to-board connector that electrically couples the circuit board to a ground reference.
Example 6: The eyewear device of any of Examples 1-5, further comprising a hinge that movably couples the temple to a front frame and a battery placed inside the at least partial cavity proximate to the hinge.
Example 7: The eyewear device of any of Examples 1-6, further comprising an audio transducer placed inside the at least partial cavity between the circuit board and the battery.
Example 8: The eyewear device of any of Examples 1-7, further comprising a first ground plane positioned between the battery and a first side of the temple and a second ground plane positioned between the battery and a second side of the temple opposite the first side of the temple.
Example 9: The eyewear device of any of Examples 1-8, wherein the first ground plane is defined at least in part by a cutout that follows at least a portion of a perimeter of the battery.
Example 10: The eyewear device of any of Examples 1-9, wherein a first dipole positioned proximate to the hinge, the first dipole comprising at least one of the first and second ground planes, and a second dipole positioned proximate to a tip of the temple.
Example 11: The eyewear device of any of Examples 1-10, wherein the first and second dipoles each comprise opposing ends and a middle region that experiences higher current than the opposing ends and lower electric fields than the opposing ends.
Example 12: The eyewear device of any of Examples 1-11, wherein the first dipole comprises a first open-circuit end and a first shorting patch positioned approximately one-quarter wavelength from the first open-circuit end, and the second dipole comprises a second open-circuit end and a second shorting patch positioned approximately one-quarter wavelength from the second open-circuit end.
Example 13: The eyewear device of any of Examples 1-12, wherein the antenna is disposed on a flexible connector that spans approximately a length of the at least partial cavity or the temple.
Example 14: The eyewear device of any of Examples 1-13, wherein the flexible connector comprises one or more communication signals between an audio transducer and a circuit board, a power signal, and/or a ground reference.
Example 15: The eyewear device of any of Examples 1-14, further comprising at least one of a capacitive touch sensor and/or a microphone.
Example 16: The eyewear device of any of Examples 1-15, further comprising an additional temple, wherein the antenna facilitates exchanging wireless communications with an additional antenna communicatively coupled to a circuit board placed inside the additional temple.
Example 17: A system comprising (1) an eyewear frame dimensioned to be worn by a user, the eyewear frame comprising (A) a temple that forms an at least partial cavity and (B) a hinge that movably couples the temple to a front frame, (2) an antenna that is (A) placed inside the at least partial cavity and (B) dimensioned commensurate with a full wavelength of a carrier frequency to be applied to the antenna, and (3) a battery placed inside the at least partial cavity proximate to the hinge.
Example 18: The system of Example 17, further comprising a circuit board placed inside the at least partial cavity proximate to a tip of the temple, wherein the antenna is communicatively coupled to the circuit board.
Example 19: The system of either Example 17 or Example 18, further comprising an audio transducer placed inside the at least partial cavity between the circuit board and the battery.
Example 20: A method comprising (1) forming an at least partial cavity inside a temple of an eyewear device, (2) placing, inside the at least partial cavity, an antenna dimensioned commensurate with a full wavelength of a carrier frequency to be applied to the antenna, and (3) placing a battery inside the at least partial cavity proximate to a hinge of the eyewear frame.

The preceding description has been provided to enable others skilled in the art to best utilize various aspects of the exemplary embodiments disclosed herein. This exemplary description is not intended to be exhaustive or to be limited to any precise form disclosed. Many modifications and variations are possible without departing from the spirit and scope of the present disclosure. The embodiments disclosed herein should be considered in all respects illustrative and not restrictive. Reference may be made to any claims appended hereto and their equivalents in determining the scope of the present disclosure.

Unless otherwise noted, the terms “connected to” and “coupled to” (and their derivatives), as used in the specification and/or claims, are to be construed as permitting both direct and indirect (i.e., via other elements or components) connection. In addition, the terms “a” or “an,” as used in the specification and/or claims, are to be construed as meaning “at least one of.” Finally, for ease of use, the terms “including” and “having” (and their derivatives), as used in the specification and/or claims, are interchangeable with and have the same meaning as the word “comprising.”

What is claimed is:

1. An eyewear device comprising:
a temple that comprises an at least partial cavity; and
an antenna that is:
placed inside the at least partial cavity; and
dimensioned commensurate with a full wavelength of a carrier frequency to be applied to the antenna.

2. The eyewear device of claim 1, further comprising a circuit board placed inside the at least partial cavity proximate to a tip of the temple, wherein the antenna is communicatively coupled to the circuit board.

3. The eyewear device of claim 2, wherein the antenna is communicatively coupled to the circuit board via at least one fastener.

4. The eyewear device of claim 3, wherein the at least one fastener comprises a spring clip.

5. The eyewear device of claim 2, further comprising a flexible board-to-board connector that electrically couples the circuit board to a ground reference.

6. The eyewear device of claim 1, further comprising:
a hinge that movably couples the temple to a front frame; and
a battery placed inside the at least partial cavity proximate to the hinge.

7. The eyewear device of claim 6, further comprising an audio transducer placed inside the at least partial cavity between a circuit board and the battery.

8. The eyewear device of claim 6, further comprising:
a first ground plane positioned between the battery and a first side of the temple; and
a second ground plane positioned between the battery and a second side of the temple opposite the first side of the temple.

9. The eyewear device of claim 8, wherein the first ground plane is defined at least in part by a cutout that follows at least a portion of a perimeter of the battery.

10. The eyewear device of claim 8, wherein the antenna comprises:
a first dipole positioned proximate to the hinge, the first dipole comprising at least one of the first and second ground planes; and
a second dipole positioned proximate to a tip of the temple.

11. The eyewear device of claim 10, wherein the first and second dipoles each comprise opposing ends and a middle region that experiences:
higher current than the opposing ends; and
lower electric fields than the opposing ends.

12. The eyewear device of claim 10, wherein:
the first dipole comprises:
a first open-circuit end; and
a first shorting patch positioned approximately one-quarter wavelength from the first open-circuit end; and
the second dipole comprises:
a second open-circuit end; and
a second shorting patch positioned approximately one-quarter wavelength from the second open-circuit end.

13. The eyewear device of claim 1, wherein the antenna is disposed on a flexible connector that spans approximately a length of the at least partial cavity or the temple.

14. The eyewear device of claim 13, wherein the flexible connector comprises at least one of:
one or more communication signals between an audio transducer and a circuit board;
a power signal; and
a ground reference.

15. The eyewear device of claim 1, further comprising at least one of:
a capacitive touch sensor; or
a microphone.

16. The eyewear device of claim 1, further comprising an additional temple, wherein the antenna facilitates exchanging wireless communications with an additional antenna communicatively coupled to a circuit board placed inside the additional temple.

17. A system comprising:
an eyewear frame dimensioned to be worn by a user, the eyewear frame comprising:
a temple that forms an at least partial cavity; and
a hinge that movably couples the temple to a front frame;
an antenna that is:
placed inside the at least partial cavity; and
dimensioned commensurate with a full wavelength of a carrier frequency to be applied to the antenna; and
a battery placed inside the at least partial cavity proximate to the hinge.

18. The system of claim 17, further comprising a circuit board placed inside the at least partial cavity proximate to a tip of the temple, wherein the antenna is communicatively coupled to the circuit board.

19. The system of claim 18, further comprising an audio transducer placed inside the at least partial cavity between the circuit board and the battery.

20. A method comprising:
forming an at least partial cavity inside a temple of an eyewear device;
placing, inside the at least partial cavity, an antenna dimensioned commensurate with full wavelength of a carrier frequency to be applied to the antenna; and
placing a battery inside the at least partial cavity proximate to a hinge of the eyewear device.
